(19) United States
(12) Patent Application Publication
(10) Pub. No.: US 2003/0023493 A1
(43) Pub. Date: Jan. 30, 2003

(54) Computer system provided in a home for inventory management, and inventory management system using home server

(75) Inventors: Shinichiro Ohashi, Hyogo (JP); Yoshio Inoue, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/178,543

(22) Filed: Jun. 25, 2002

(30) Foreign Application Priority Data
Jul. 26, 2001 (JP) 2001-226052(P)

(51) Int. Cl. G06F 17/60

(52) U.S. Cl. 705/16

(57) ABSTRACT

Merchandise information such as an expiration date, a price and the quantity of merchandise purchased by a purchaser is registered at a POS terminal at a store, and the merchandise information is recorded in an IC card by an IC card controller. At home, an IC card controller of a home server reads the merchandise information stored in the IC card and applies the same to a CPU. The CPU adds information of purchased merchandise to current inventory information for inventory management, sets the expiration date as an alarm time in a management table, and displays merchandise close on the expiration date onto a liquid crystal panel.

### BACKGROUND OF THE INVENTION

1. Field of the Invention

The present invention relates to a computer system provided in a home for inventory management, and inventory management system using home server. More particularly, the present invention relates to a home server for reading information including an expiration date, a price or the quantity of merchandise and the like from an IC (Integrated Circuit) card, into which such information has been registered at POS (Point of Sale) system at a supermarket etc., and an inventory management system for inventory and date management using the home server.

2. Description of the Background Art

Conventionally, in shopping at a supermarket or the like, one may receive a receipt with merchandise information printed thereon at the store, bring the receipt back home, transcribe the information to his/her household account book or input it into a spreadsheet program of a personal computer to manage the account book. Furthermore, in shopping, especially when purchasing various and many items collectively once a week, for example, one may usually examine shortage items at home to determine items for the next purchase.

Japanese Patent Laying-Open No. 9-26993 discloses a shopping system in which merchandise information is written in an IC card at a store, the information written in the IC card is registered with a personal computer at home, a purchase history file is created on a hard disk from the merchandise information, an average purchase interval for each item is calculated based on the purchase history information to input the next scheduled shopping date, and an item to be purchased on a scheduled shopping date is displayed.

The above shopping system, however, only displays an item to be purchased next time, and does not have a function of managing the date and inventory of purchased merchandise.

### SUMMARY OF THE INVENTION

Therefore, the main object of the present invention is to provide a computer system provided in a home for inventory management capable of managing the date and inventory of purchased merchandise at home, and an inventory management system using home server.

In summary, the present invention includes: a storage unit for externally receiving and storing electronic information including at least an item name and an expiration date of merchandise; a timing unit for counting at least the present date; and a processing unit for comparing the expiration date included in the electronic information stored in the storage unit with the date counted by the timing unit to specify an item of merchandise to be consumed according to the comparison result.

Therefore, the present invention enables management of expiration of purchased items, so that expired merchandise being left in a refrigerator and purchase of unnecessary merchandise, can be prevented.

According to another aspect, the present invention provides an inventory management system, including: a point of sale terminal for registering merchandise information including at least information of an expiration date, a price and the quantity of merchandise; a portable terminal for a purchaser, capable of recording the merchandise information by connecting to the point of sale terminal; and a home terminal for reading and registering the merchandise information from the portable terminal. The home terminal includes a logic operation unit for managing an inventory of purchased merchandise using the merchandise information registered in the home terminal.

Therefore, the present invention enables management of inventory of purchased merchandise, so that expired merchandise being left in a refrigerator and purchase of unnecessary merchandise, can be prevented.

In addition, according to a further aspect, the present invention provides an inventory management system, including: a point of sale terminal for registering merchandise information including at least information of an expiration date, a price and the quantity of merchandise; and a home terminal connected to the point of sale terminal through a network for reading and registering the merchandise information. The home terminal includes a logic operation unit for managing an inventory of purchased merchandise using the registered merchandise information.

Therefore, the present invention enables management of inventory of purchased merchandise based on the merchandise information registered through the network such as the Internet, so that an inventory of unnecessary merchandise can be suppressed and stocks of necessary items will not run out.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall configuration of an inventory management system in accordance with an embodiment of the present invention.

FIG. 2 is a block diagram of a home server shown in FIG. 1.

FIG. 3 is a flowchart illustrating an operation of inserting an IC card in accordance with an embodiment of the present invention.

FIG. 4 is a flowchart illustrating an operation of transferring data for a household account book to a personal computer.

FIG. 5 is a flowchart illustrating an operation of transferring cooking information to the home server.

FIG. 6 is a block diagram showing a configuration of an inventory management system in accordance with another embodiment of the present invention.

### DESCRIPTION OF THE PREFERRED EMBODIMENTS

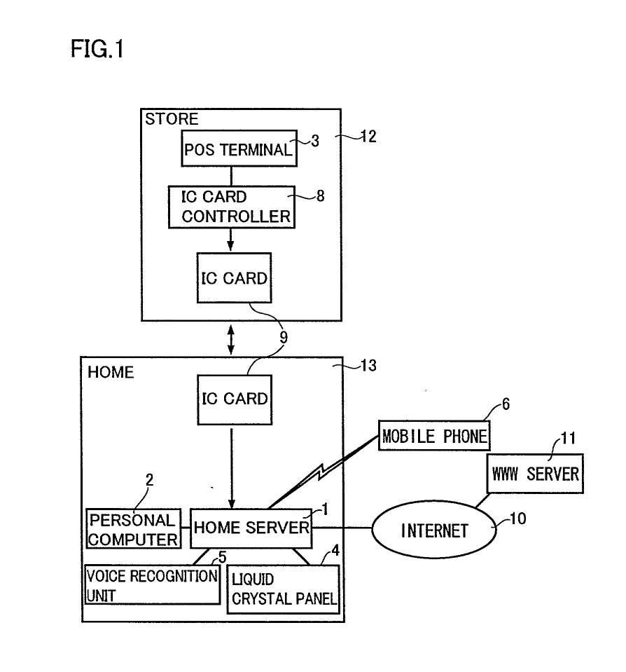

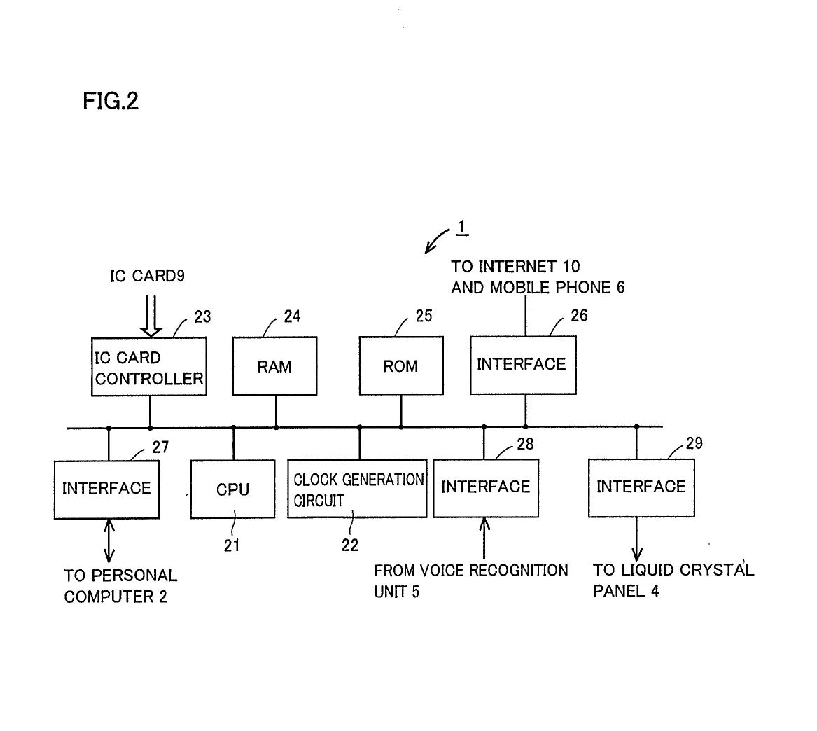

FIG. 1 is a block diagram showing an overall configuration of an inventory management system in accordance with an embodiment of the present invention, and FIG. 2 is a block diagram of a home server 1 shown in FIG. 1.

Referring to FIG. 1, in a store 12, a POS terminal 3 as a point-of-sale terminal and an IC card controller 8 are installed. POS terminal 3 is provided for referring to and registering merchandise information including information of an expiration date, a price and the quantity of merchandise purchased by a purchaser. IC card controller 8 records the merchandise information that is referred to by POS terminal 3 into an IC card 9 as a portable terminal. Note that a portable terminal is not limited to IC card 9, but includes a magnetic card or anything capable of registering merchandise information.

On the other hand, at home 13, a home server 1, a personal computer 2, a liquid crystal panel 4, and a voice recognition unit 5 are provided. Home server 1 is provided for managing an inventory by comparing merchandise in stock with merchandise to be purchased, and is configured with a CPU 21 as an operating unit, a clock generation circuit 22, an IC card controller 23, an RAM 24, an ROM 25, and interfaces 26, 27, 28, 29, each being connected to an internal bus.

IC card controller 23 reads merchandise information from IC card 9 having that merchandise information recorded therein and provides the information to CPU 21. CPU 21 is operated according to a program stored in ROM 25 based on a clock signal from clock generation circuit 22, and stores the processed data and the like into RAM 24.

Personal computer 2 performs both an input function and a display function for home server 1, and functions as a kind of terminal for referring to and updating the merchandise information which is managed by home server 1 with respect to the inventory. For this purpose, personal computer 2 is connected to the internal bus through interface 27. Liquid crystal panel 4 is connected to the internal bus through interface 29 for displaying the merchandise information etc., and voice recognition unit 5 is connected to the internal bus through interface 28 for inputting information concerning merchandise and the like, using voice.

It is noted that a mobile phone 6 is connectable to home server 1 through interface 26, and can be used as an input function and a display function. Advantageously, use of mobile phone 6 in this manner enables reference of merchandise being in stock at home and updating of information thereof, from a remote location.

Furthermore, interface 26 is connected to a WWW server 11 as other network terminal through the Internet 10, and cooking information such as a recipe is transferred from WWW server 11.

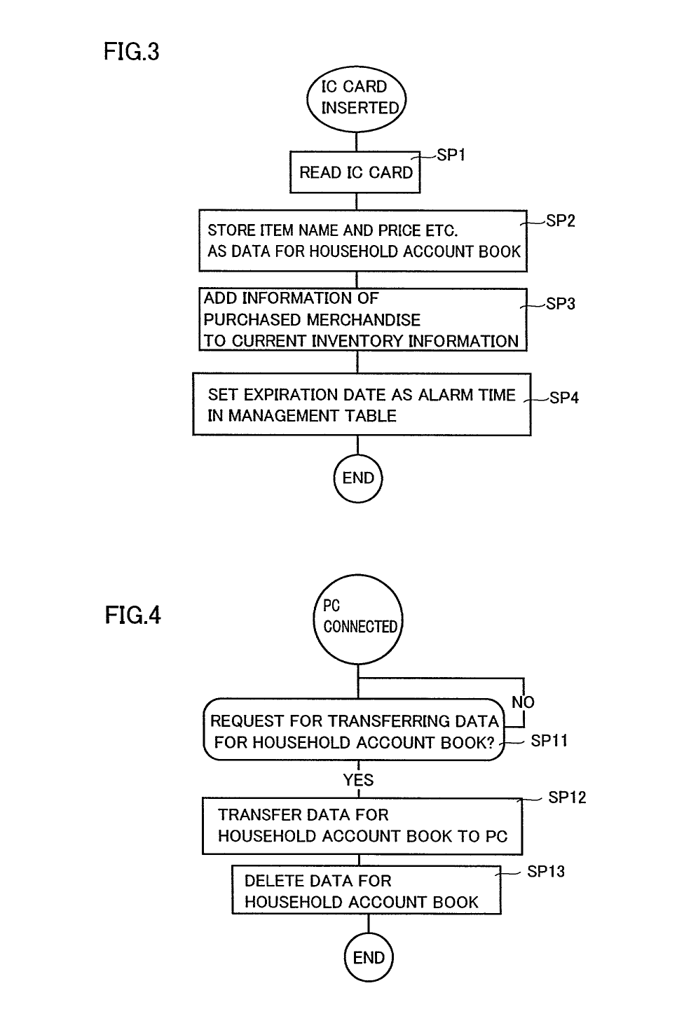

FIG. 3 is a flowchart illustrating an operation of inserting the IC card in accordance with an embodiment of the present invention, FIG. 4 is a flowchart illustrating an operation of transferring data for a household account book to personal computer 2, and FIG. 5 is a flowchart illustrating an operation of accessing WWW server 11.

First referring to FIG. 3, the operation when IC card 9 is inserted into IC card controller 23 within home server 1 will be described. In step SP (briefly referred to SP in the figures) 1, IC card controller 23 reads the merchandise information such as an item name, a price, an expiration date registered in IC card 9 and provides the information to CPU 21. CPU 21, in step SP 2, stores that merchandise information into RAM 24 as data for a household account book, and, in step SP 3, adds the information of the purchased merchandise to the current inventory information. Then, in step SP 4, the expiration date is set as an alarm time in a management table.

CPU 21 has a timer function as a timing unit for counting time in software manner as well as a function of a comparing unit for comparing the present time and date as counted with the input expiration date. When it is determined that the present time and date passes over the expiration date, it displays an item name of the corresponding merchandise on liquid crystal panel 4 as an alarm unit through interface 29.

Therefore, in accordance with the present embodiment, since an expiration date of an inventory item can be automatically controlled, the likelihood of leaving expired merchandise is eliminated. It is noted that the alarm can be displayed before an expiration date by changing a comparison condition. Furthermore, a list of the registered merchandise can be referred to from mobile phone 6 away from home.

Next, referring to FIG. 4, when data for a household account book is managed by personal computer 2, a request for transferring the data for household account book is output from personal computer 2 to home server 1 through interface 27. In CPU 21, when it is determined that there is a request for transferring the data for household account book in step SP 11, the data for household account book is transferred to personal computer 2 in step SP 12, and that data for household account book is deleted in step SP 13. This eliminates the trouble of manually inputting merchandise information for creating a household account book.

An operation of acquiring cooking information from WWW server 11 shown in FIG. 1 will now be described with reference to FIG. 5. CPU 21 has an acquiring means for accessing WWW server 11 through the Internet 10 in step SP 21 and for downloading cooking information such as a recipe in step SP 22. Then, in step SP 23, material data is extracted from the acquired recipe, and in step SP 24, the material data is compared with data of merchandise currently being in stock at home. The required material according to the comparison result is displayed on liquid crystal panel 4 in step SP 25, and is stored as a shopping list in step SP 26. A purchaser may buy based on the shopping list. It is noted that the shopping list may be printed using a printer.

Furthermore, conversely, a list of dishes that can be prepared from the material in stock at home can be retrieved from the Internet.

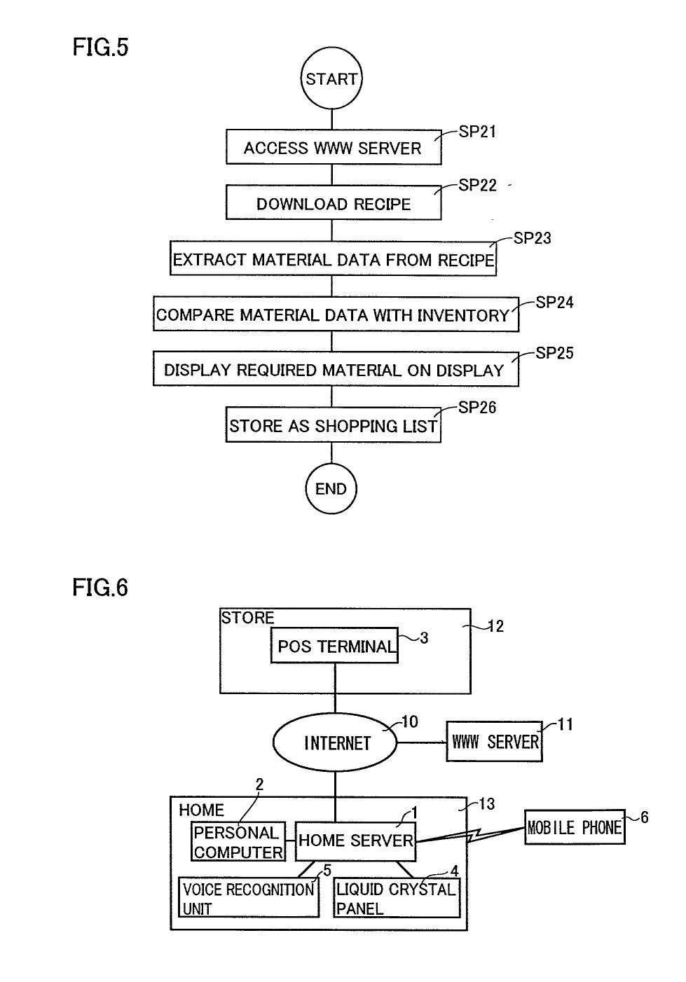

FIG. 6 is a block diagram showing another embodiment of the present invention. In the embodiment shown in FIG. 1, the merchandise information registered at POS terminal of store 12 is recorded in IC card 9. In the present embodiment, however, POS terminal 3 at store 12 and home server 1 at home 13 are connected through the Internet 10, so that the merchandise information registered at POS terminal 3 can be immediately registered in home server 1 through the Internet 10. Therefore, a purchaser can do the shopping without having to carry IC card 9 shown in FIG. 1, and in addition, a process for transferring the merchandise information from IC card 9 to home server 1 becomes unnecessary, thereby enabling a fast inventory management at home.

Therefore, in accordance with the present embodiment, a list of required material can be created based on the cooking information acquired through the Internet 10 by home server 1. This eliminates the trouble of transferring information from IC card 9 to home server 1.

As described above, the embodiment of the present invention provides for externally receiving and storing electronic information including at least an item name and an expiration date of merchandise, comparing the expiration date included in the stored electronic information, and specifying merchandise to be consumed according to the comparison result, so that the likelihood that expired merchandise is left in a refrigerator, for example, can be eliminated.

Furthermore, the present invention provides for registering merchandise information at a point-of-sale terminal, recording that merchandise information in a portable terminal, reading the merchandise information from the portable terminal at a home terminal to manage an inventory of purchased merchandise, so that an appropriate quantity of merchandise can always be stored at home.

Still further, an inventory of purchased merchandise can be managed not using a portable terminal, but by connecting a point-of-sale terminal with a home terminal through a network and by registering merchandise information registered at the point-of-sale terminal into the home terminal through the network.

In addition, since an alarm is raised for expired merchandise, the likelihood of leaving expired merchandise can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A computer system provided in a home, comprising:
a storage unit for externally receiving and storing electronic information including at least an item name and an expiration date of merchandise;
a timing unit for counting at least the present date; and
a processing unit for comparing the expiration date included in the electronic information stored in said storage unit with the date counted by said timing unit to specify merchandise to be consumed according to a comparison result.

2. The computer system provided in a home according to claim 1, further comprising
a reading unit for reading electronic information stored in an IC card, wherein
said electronic information is read from said IC card by said reading unit and stored in said storage unit.

3. The computer system provided in a home, according to claim 1, further comprising
an interface unit connected to a network, wherein
said electronic information is acquired through said interface unit and stored in said storage unit.

4. The computer system provided in a home according to claim 1, further comprising
a display for displaying a content of the electronic information stored in said storage unit.

5. The computer system provided in a home according to claim 1, wherein
the electronic information stored in said storage unit can be updated from an external device.

6. The computer system provided in a home according to claim 1, wherein
the electronic information stored in said storage unit can be read and updated through radio communication.

7. The computer system provided in a home according to claim 1, wherein
the electronic information stored in said storage unit can be read and updated through a personal computer.

8. A computer system provided in a home, comprising:
an interface unit connected to a network,
a storage unit storing electronic information including at least item name of merchandise, and
a processing unit capable of downloading cooking information from said network through interface unit and comparing the cooking information and the electronic information stored in said storage unit to specify merchandise required for cooking.

9. An inventory management system, comprising:
a point-of-sale terminal for registering merchandise information including at least information of an expiration date, a price and a quantity of merchandise;
a portable terminal for a purchaser, capable of recording said merchandise information by connecting to said point-of-sale terminal; and
a home server for reading and registering said merchandise information from said portable terminal, wherein
said home server includes a processing unit for managing an inventory of purchased merchandise using said merchandise information registered in the home server.

10. An inventory management system, comprising:
a point-of-sale terminal for registering merchandise information including at least information of an expiration date, a price and a quantity of merchandise; and
a home server connected to said point-of-sale terminal through a network for reading and registering said merchandise information, wherein
said home server includes a processing unit for managing an inventory of purchased merchandise using said merchandise information registered in the home server.

11. The inventory management system according to claim 9, wherein
said home server includes
a storage unit for storing said merchandise information, and
a writing unit for deleting or updating information concerning consumed merchandise among the merchandise information stored in said storage unit.

12. The inventory management system according to claim 9, wherein
said home server includes
a timing unit for obtaining the present time and date,
a comparing unit for comparing the expiration date of said merchandise information with the present time and date counted by said timing unit, and
an alarm unit for raising an alarm according to a determination made by said comparing unit that the expiration date approaches.

13. The inventory management system according to claim 9, wherein
said home server includes a display for displaying stored information.

14. The inventory management system according to claim 9, wherein
said home server includes an input unit for inputting information of consumed merchandise.

15. The inventory management system according to claim 9, wherein
a liquid crystal panel is used for said display.

16. The inventory management system according to claim 9, wherein
said input unit includes a voice input unit for inputting utilizing voice recognition.

17. The inventory management system according to claim 9, wherein:
said home server includes
a display for displaying stored information, and
an input unit for inputting information of consumed merchandise; and
a personal computer is used as said display and said input unit.

18. The inventory management system according to claim 9, wherein:
said home server includes
a display unit for displaying stored information, and
an input unit for inputting information of consumed merchandise; and
a mobile phone is used as said display unit and said input unit for enabling update and reference of an inventory at a remote location.

19. The inventory management system according to claim 9, wherein:
said home server includes
an acquiring unit connected to a network for acquiring cooking information from other network terminal,
a comparing unit for comparing the acquired cooking information with a current inventory, and
a display unit for displaying a required material and amount as determined by said comparing unit.
